(19) United States
(12) Patent Application Publication
(10) Pub. No.: US 2006/0106490 A1
(43) Pub. Date: May 18, 2006

(54) Vending machine monitoring system

(75) Inventors: Donald W. Howell, Troutville, VA (US); Michael L. Campbell, Roanoke, VA (US)

Correspondence Address: STEVENS DAVIS MILLER & MOSHER, LLP, 1615 L STREET, NW, SUITE 850, WASHINGTON, DC, 20036, US

(73) Assignee: ADMMicro, LLC, Roanoke, VA (US)

(21) Appl. No.: 11/272,174

(22) Filed: Nov. 14, 2005

Related U.S. Application Data
(60) Provisional application No. 60/627,183, filed on Nov. 15, 2004.

(51) Int. Cl. G06F 17/00

(52) U.S. Cl. 700/233

(57) ABSTRACT

A system and method for using mesh technology to remotely monitor a plurality of vending machines is provided. Each vending machine includes a node that supports the DEX/UCS standard using customized off-the-shelf mesh networking and metering components to reach a gateway node included in a vending machine to provide access to and by a vending machine data center.

### CROSS-REFERENCE TO RELATED APPLICATION

This claims the benefit of U.S. provisional patent application No. 60/627,183, filed Nov. 15, 2004, incorporated herein by reference in its entirety.

### BACKGROUND OF THE INVENTION

1. Field of the Invention

The present invention relates to remotely monitoring co-located vending machines using wireless technology to reach a gateway node for accessing a vending machine control center.

2. Description of the Related Art

Companies that sell products through vending machines face a significant ongoing challenge—that is stocking and maintaining those machines upon which their business depends. A major cost associated with operating vending machines has to do with the wide geographic distribution of such machines, and the necessity of manual inspection to determine stock levels and to ensure that machines are operating properly. This cost can be significantly reduced through use of automatic remote monitoring designed to provide timely information to facilitate product stocking and vending machine maintenance.

Industry standards have gained acceptance, such as Data Exchange Uniform Code Standard (DEX/UCS), which define how to communicate with newer “smart” vending machines. These standards serve as a useful foundation upon which vending machine monitoring systems can be built and have received international consensus support, see below and Appendix A for a discussion of DEX in “V-Commerce”.

### SUMMARY OF THE INVENTION

This invention provides a system and method for remote monitoring of vending machines where the vending machines are equipped with “smart” controllers, such as DEX-enabled or DEX-compliant machines. While other systems have been designed for this purpose, this invention discloses a method of combining local area wireless data communications with various forms of wide area data communications, through a gateway mechanism, to provide for a more cost effective automatic monitoring system.

In a preferred embodiment, a local area (relatively short distance) wireless interface node (WIN) is installed in each of a plurality of vending machines. Each wireless interface node employs mesh networking techniques to dynamically and automatically route data signals to a gateway node located within radio range of a local grouping of vending machines—such as all machines within the same building, campus, etc. As one consequence there is a need for only one wide area (long distance) connection back to a vending company's data center from each local grouping of machines. In this embodiment, the gateway node provides various forms of wide area data communications, including cellular data, telephone modem, and Internet connectivity. This flexibility allows for the use of the most cost-effective wide area data communications medium, which may vary from one location to another.

The mesh networking techniques built into each wireless interface node allow data to be moved across a local area (building, campus, etc.) by “hopping” from node to node. This allows for use of low powered, cost-effective wireless technologies. Mesh networking techniques allow for dynamic changes in the network topology such that nodes can be automatically added or removed. Thus, vending machines can be installed or removed with little administration and minimal impact on overall network performance.

The system of this invention delivers information to a Vending Company Data Center in a native data format of the vending machine. This facilitates expanded use of existing mechanisms, which have been developed to support “smart” vending machines.

DEX Standards

DEX is an acronym for Data Exchange and is the abbreviation for DEX/UCS which stands for Data Exchange Uniform Code Standard. DEX is the key to technological advancements in the vending industry worldwide. Since DEX/UCS recently received international consensus support, industry experts believe this will further facilitate a movement toward consistent data formatting. In the past, machine manufacturers varied in how data exchange transmissions occurred. Now DEX designers and equipment engineers have agreed on a common linkage. While not all vend operators demand identical informational output, machines will possess similar data capabilities for delivering consistent reports. For example, common data set elements in the DEX standard are number of bills held in the bill stacker, quantity and denomination of coins stored in the coin box, machine inventory, and product sales tracking. DEX provides an indisputable, auditable accounting method for actual cash collections, units sold, and product price.

During the past decade, the National Automatic Merchandising Association (NAMA) established a communication protocol for the electronic retrievable of machine-level information via data polling. As a consequence, vending machines are now manufactured as DEX-enabled and are often labeled as DEX-compliant. Basic DEX extraction includes sales, cash collections, product movement (sales mix) and related information. DEX data retrieval can be accomplished via three distinct polling modes: 1) local polling, 2) dial-up polling, or 3) wireless polling.

Local polling incorporates a hand-held device (or pocket probe) designed to plug connect to a machine-based DEX-port. Once the connection is established, the device is used to download transactional data. A typical DEX data download (machine to hand-held device) takes approximately five seconds. Field collected data is later transferred from the hand-held device to a central office computer for processing and analysis.

Dial-up polling (telephone line), and wireless polling enable remote access to DEX data without requiring a physical presence at the point of transaction. Once a valid connection is established, DEX data can be collected to evaluate and analyze. DEX-enabled handhelds plug into a vending machine port and automatically download stored data. While most information deals with sales, there are several important elements of auditing. For example, the amount of cash that should be in a machine at the close of a sales period. A route driver, unable to view the DEX electronic record, will have cash collections compared against the machine-level electronic record.

A DEX-enabled machine relies upon a DEX add-on to enable a handheld device to be plugged into the back portion of a vending machine. The vending machine then communicates its unique identifying number and stored data is extracted. An important element of this data is the machine's service history, including the last date the machine was serviced. Once the route driver transfers DEX information to the handheld and in turn relays it back to headquarters, an audit can be performed. Since captured data is not accessible or editable by the route driver, cash accountability is assumed accurate and complete. Also, the ability to track product information at the machine level enhances productivity as a route time is improved and manual data entry is eliminated.

DEX specifies a data format to enable all different types of machines and machine models to communicate electronically in a similar manner. The DEX information available includes: sales, cash collections, product movement and other vending machine activities. Additionally, the DEX specification contains a standard for reporting error codes for payment validation, jams and other operational problems, all of which use ASCII text blocks for report generation.

The main benefit of line-item tracking is accountability and machine menu development. A DEXBuzzBox system operates through a wireless transmitter installed in a DEX-equipped vending machine that transmits machine-level data to a receiver (BuzzBox) in the route driver's truck. The BuzzBox may be equipped with a portable printer and a hand-held computer. The BuzzBox can be used to determine which machines at the location require service (and which do not) and generates a detailed pick list for the driver to restock the machines prior to entering the facility. The driver's productivity is enhanced as there is only one trip into the building.

### BRIEF DESCRIPTION OF THE DRAWINGS

FIG. 1 is a vending machine monitoring system according to the present invention.

FIG. 2 is an off-the-shelf EkaNet Node from Eka Systems that can provide a basis for a wireless interface node (WIN) (FIG. 1) of the present invention.

FIG. 3 illustrates a vending machine modified with a WIN configured as an off-the-shelf EkaNet Node with additional firmware for vending machine serial data interface according to an embodiment of the present invention.

FIG. 4 is an off-the-shelf Spider SA-GL GSM modem from Enfora.

FIG. 5 illustrates the use of a GSM modem in a gateway node for wireless connectivity to a remote vending machine monitoring data center.

FIG. 6 illustrates the use of a telephone modem in a gateway node for wired connectivity to a remote vending machine monitoring data center.

FIG. 7 illustrates use of a serial to Ethernet converter in a gateway node for wired connectivity to a remote vending machine monitoring data center.

FIG. 8 illustrates a wireless interface node firmware flow chart involving WIN initiated data communications for one possible firmware flow chart for each WIN in a system configured such that all local area data communications, between WINs and the local Gateway Node, are initiated by WINs.

FIG. 9 is related to FIG. 8 and illustrates a gateway node firmware flow chart involving WIN initiated data communications for one possible firmware flow chart for the local Gateway Node in the same system configuration as referenced for FIG. 8, where all local area data communications, between WINs and the local Gateway Node, are initiated by WINs.

FIG. 10 illustrates a wireless interface node firmware flow chart involving gateway initiated data communications involving another possible firmware flow chart for each WIN in a system configured such that all local area data communications are initiated by the local Gateway Node.

FIG. 11 is related to FIG. 10 and illustrates a gateway node firmware flow chart involving gateway initiated data communications for one possible firmware flow chart for the local Gateway Node in the same system configuration as referenced for FIG. 10, where all local area data communications are initiated by the local Gateway Node.

### DETAILED DESCRIPTION OF THE EMBODIMENTS

In the following description, by way of explanation and not limitation, specific details are set forth such as the particular architecture, interfaces, techniques, etc., in order to provide a thorough understanding of the present invention. However, it will be apparent to those skilled in the art that the present invention may be practiced in other embodiments that depart from these specific details.

The present invention provides a system and method for a vending machine monitoring system.

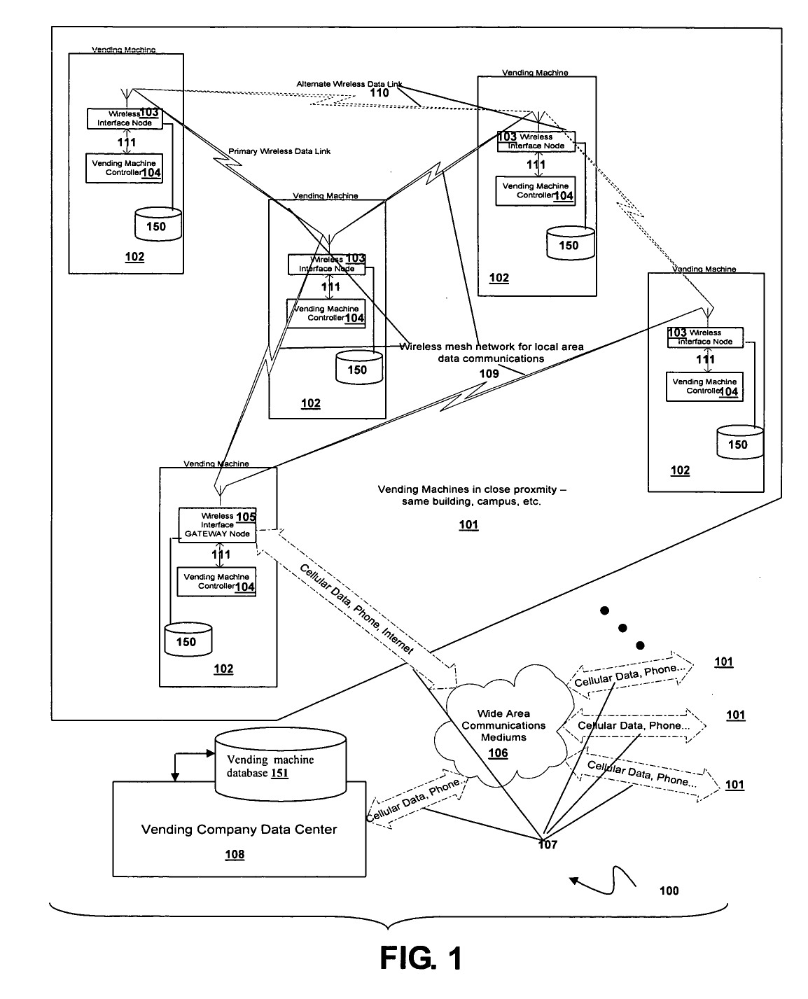

Referring now to FIG. 1, a preferred embodiment is illustrated of a vending machine monitoring system 100 according to the present invention. The system 100 comprises at least one grouping 101 of a plurality of vending machines 102 distributed such that each vending machine 102 of a grouping 101 is within radio range of at least one other vending machine 102 of the grouping of vending machines 101. In each of the at least one grouping 101 all but one of the plurality of vending machines 102 further comprises a wireless interface node (WIN) 103 and one vending machine of said plurality comprises a wireless interface gateway node. In each of the at least one grouping 101 each of said plurality of vending machines 102 further comprises a vending machine controller module 104. In each said at least one grouping 101 the vending machines are physically located such that the grouping can communicate wirelessly at least via technology such as a wireless mesh network technology in a wireless mess network 109. A grouping may also further comprise an alternative wireless communication technology 110.

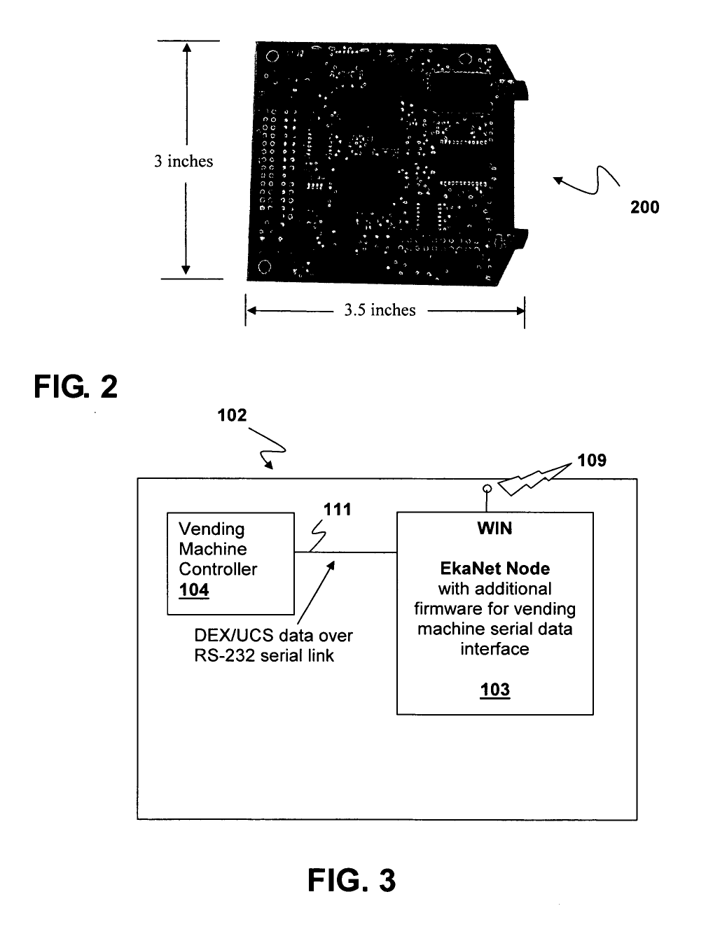

FIG. 2 is an off-the-shelf EkaNet Node 200 from Eka Systems that can provide a basis for a wireless interface node (WIN) 103 (FIG. 1) of the present invention.

FIG. 3 illustrates a vending machine 102 with WIN configured using an EkaNet Node. The vending machine 102 has a WIN 103 configured as an off-the-shelf EkaNet Node with additional firmware for vending machine serial data interface according to an embodiment of the present invention. The vending machine 102 interacts with a wireless mesh network 109. DEX/UCS data transmits over an RS-232 serial link 111 between the vending machine controller 104 and EkaNet Node 103.

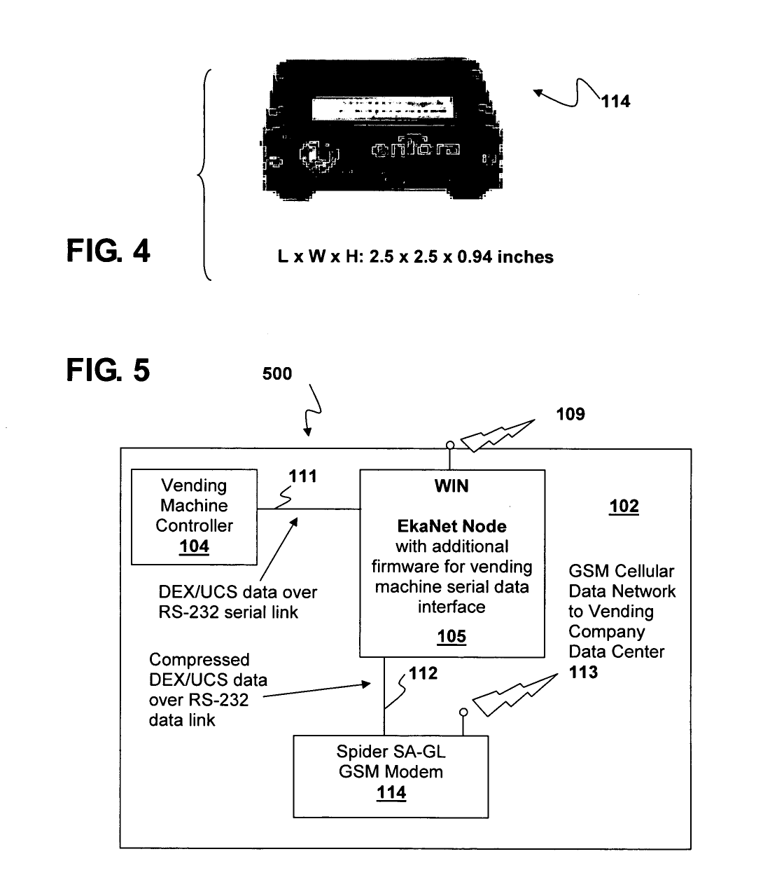

FIG. 4 is an off-the-shelf Spider SA-GL GSM modem from Enfora.

FIG. 1 shows a vending machine provided with a gateway node 105. There are a number of ways to provide a vending machine with a gateway node.

FIG. 5 illustrates a first embodiment of a vending machine 102 employing a system 500 with a gateway node with GSM cellular connectivity via a GSM modem 114 (for example a Spider SA-GL GSM Modem) for wireless connectivity to a remote vending machine monitoring data center 113. The vending machine 102 has a WIN 105 configured as an off-the-shelf EkaNet Node with additional firmware for vending machine serial data interface according to an embodiment of the present invention. The system 500 interacts with a wireless mesh network 109. DEX/UCS data transmits over an RS-232 serial link 111 between the vending machine controller 104 and EkaNet Node 105. Compressed DEX/UCS data travels over RS-232 data link 112 to the GSM modem 114. Data travels from the GSM modem 114 to the vending company data center 113 via GSM technology. The GSM technology may be replaced by any wireless technology.

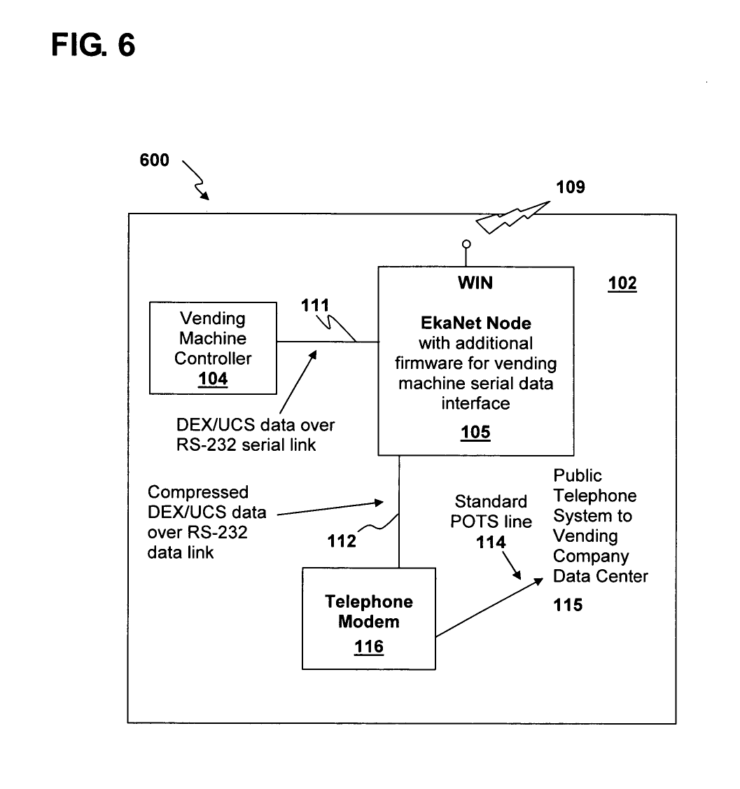

FIG. 6 illustrates a second embodiment of a vending machine 102 employing a system 600 with a gateway node with telephone connectivity via a telephone modem 116 to a remote vending machine monitoring data center 115. The vending machine 102B has a WIN 105 configured as an off-the-shelf EkaNet Node with additional firmware for vending machine serial data interface according to an embodiment of the present invention. The system 600 interacts with the wireless mesh network 109. DEX/UCS data transmits over an RS-232 serial link 111 between the vending machine controller 104 and EkaNet Node 105. Compressed DEX/UCS data travels over RS-232 data link 112 to the telephone modem 116. Data travels from the telephone modem 116 to the vending company data center 115. The transmitted data from the telephone modem 116 may travel to the vending company data center either directly along the telephone line or may travel by a combination of telephone and internet. For example, the data may travel along a phone line to the internet. From the internet the data may travel to the data center 115 or to another phone line to the data center 115.

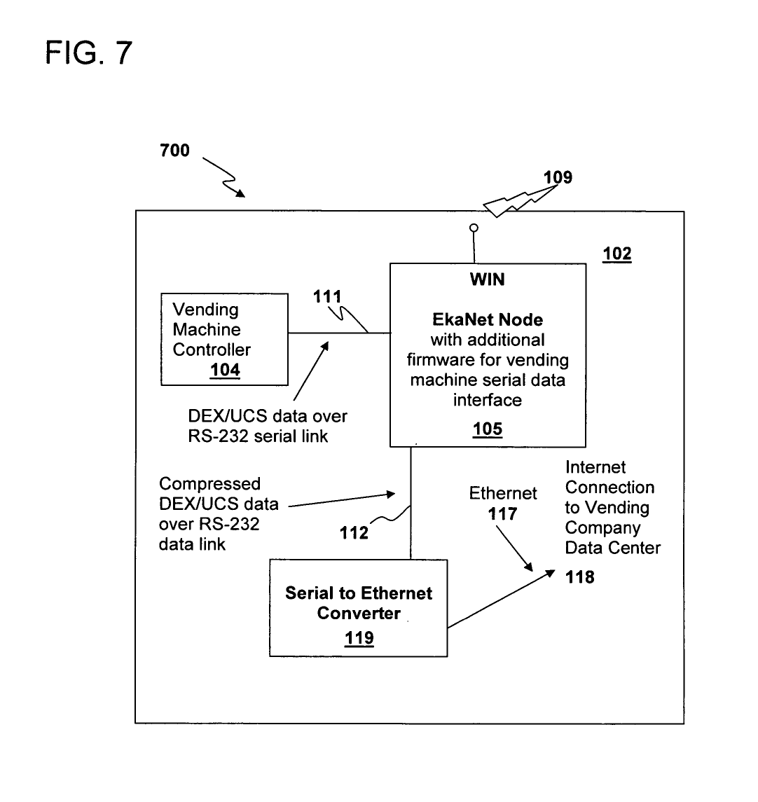

FIG. 7 illustrates a third embodiment of a vending machine 102 using a serial to Ethernet converter in a gateway node for wired connectivity to a remote vending machine monitoring data center. The vending machine 102C employs a system 700 with a gateway node with Ethernet/Internet connectivity from a serial to Ethernet converter 119 to a remote vending machine monitoring data center 118. The vending machine 102C has a WIN 105 configured as an off-the-shelf EkaNet Node with additional firmware for vending machine serial data interface according to an embodiment of the present invention. The system 700 interacts with the wireless mesh network 109. DEX/UCS data transmits over an RS-232 serial link 111 between the vending machine controller 104 and EkaNet Node 105. Compressed DEX/UCS data travels over RS-232 data link 112 to the serial to Ethernet converter 119. Then data travels from the serial to Ethernet converter 119 via the Internet to the vending company data center 118.

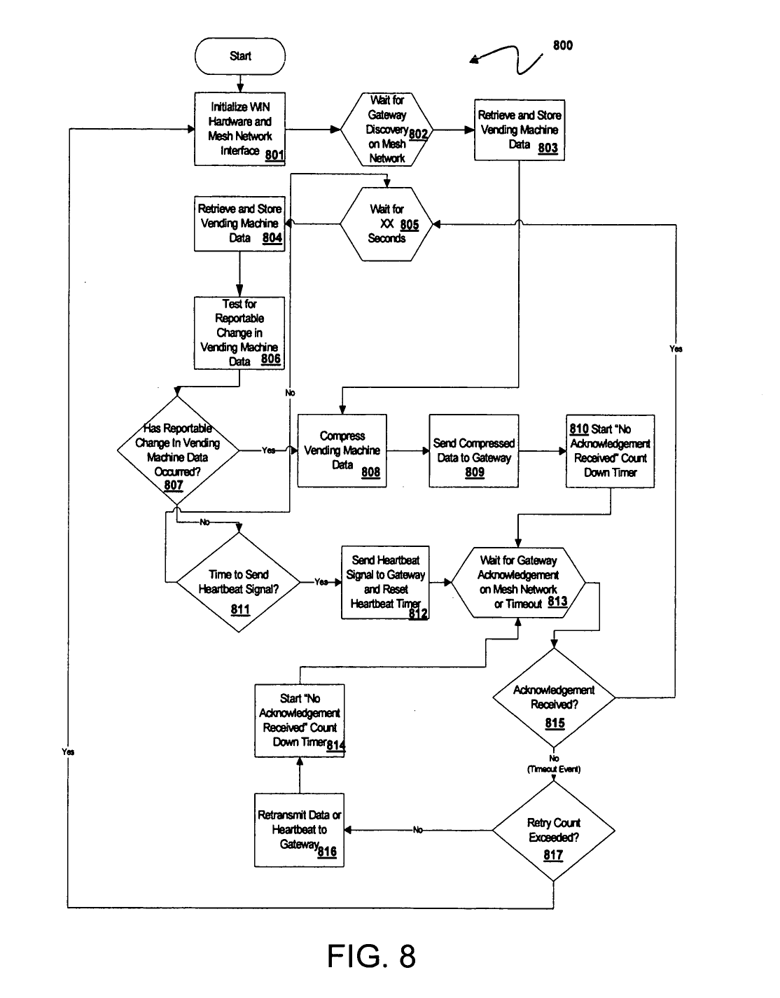

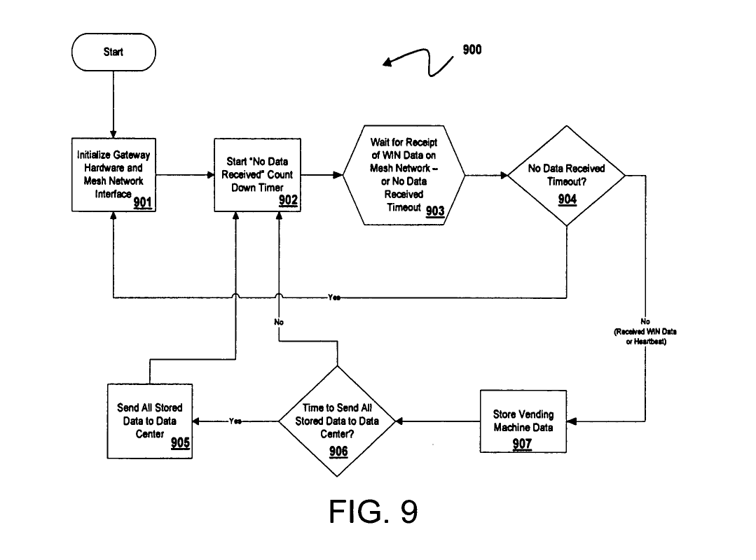

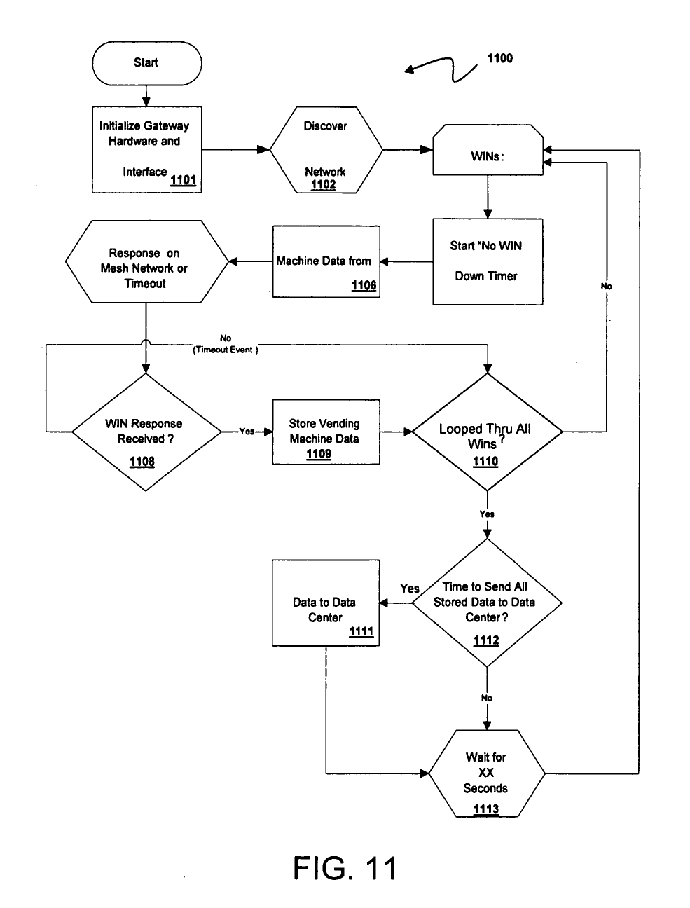

A preferred embodiment of a method of the present invention, where all local area data communications between WINs and the local Gateway Node are initiated by WINs, is illustrated in FIGS. 8 and 9 and comprises the steps of:
1. Wireless interface nodes (WINs) 103 are modified with firmware for a serial data interface and installed in each vending machine 102 that is equipped with a “smart” controller 104. Each WIN 103 periodically retrieves all data 804 from the controller 104 that is co-located in the same vending machine 102, using the serial data interface and a serial data link 111. The serial data link 111 typically is an RS-232 type. Data from the local vending machine is typically an industry standard format, such as DEX/UCS (or other standard format now or developed in the future) and a data set of the data retrieved from the controller 104 is stored in a local memory 150 (FIG. 1).
2. Simultaneously, and independently of the vending machine interface, each WIN 103 also continuously handles wireless mesh networking tasks 903 (FIG. 9), such as discovering other WIN 103 units that have recently joined or dropped off of the local mesh network 109, determining the most efficient route for wireless data traffic to the local mesh network's gateway node 105, and relaying data from other network nodes 102 (e.g., vending machines 102).
3. After retrieving data from the local vending machine controller 104 (step 1 above) step 804 (FIG. 8), each WIN 103 compares the most recently retrieved data set to the data set that was previously retrieved and stored to determine if any reportable change has occurred 807.
4. If a reportable change is detected in the vending machine data set, the WIN 103 compresses the entire data set 808 and transmits the compressed data 809 to the local wireless network's gateway node 105 through either a wireless mesh network 109 or an alternate wireless data link 110 (FIG. 1). If no change in the vending machine data set is detected for a predefined continuous period of time, each WIN 103 transmits a “heartbeat” signal 811 to indicate that it is still operating properly.
5. Upon receipt of a vending machine compressed data set or a WIN heartbeat signal, the gateway node 105 replies over the wireless mesh network 109 (or alternate wireless data link 110), to the originating WIN 103, with a message that acknowledges receipt of the original WIN's message.
6. The gateway node 105 also forwards 107 the compressed data set or heartbeat signal, step 1111 (FIG. 11), to the vending company's data center 108 over the appropriate wide-area network communications link 107 (FIG. 1). Wide-area communications mechanisms might include telephone modem, cellular data link, or Internet connection.
7. When received in the vending company's data center 108, vending machine data sets are decompressed and stored in a vending machine database 151 for further processing within the vending company's information technology systems.

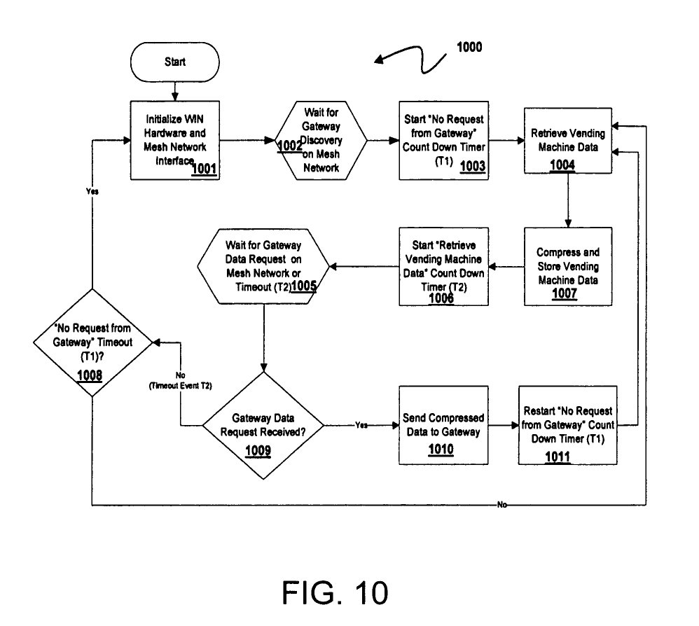

FIGS. 8-11 present detailed flows of the firmware modification according to a preferred embodiment of a WIN (FIGS. 8-9) and a Gateway Node (FIGS. 10-11).

FIG. 8 shows a wireless interface node firmware flow chart relating to WIN initiated data communication.

In particular, in FIG. 8 a flow of firmware logic in a WIN for WIN-initiated data communications is illustrated 800. At step 801 WIN hardware and mesh network interfaces are initiated. Then the WIN waits for discovery of a Gateway node on the mesh network at step 802. Following Gateway discovery the WIN retrieves and locally stores a first set of vending machine data as a previous set in the WIN at step 803, compresses the retrieved data at step 808, send the compressed data to the discovered Gateway at step 809 and then starts a No acknowledgement (No-ACK) countdown timer to wait for acknowledgement from the Gateway of a timeout at step 813. If no ACK is received (i.e., a timeout event occurred at step 815) a retry count is incremented at step 817 and if it does not exceed a pre-determined value the data or heartbeat is retransmitted at step 816. Then a No-ACK countdown timer is started at step 814 and the WIN again waits for an ACK or a timeout at step 813. If an ACK is received then at step 805 the WIN waits for a pre-determined number seconds and then retrieves and stores a next set of vending machine data at step 804. At step 806 the next set is compared with the previous set and if at step 807 no reportable change has occurred then at step 811 the WIN determines if it is time to send a heartbeat signal to the Gateway node. If no heartbeat is due to be sent, the WIN returns to step 805 and waits, as described above. If a heartbeat is due to be sent, the WIN sends a heartbeat signal to the Gateway node and resets the heartbeat timer and a No-Ack count down timer at step 812. The WIN goes to step 813 to await an Ack or a timeout, as described above.

FIG. 9 shows a gateway node firmware flow chart relating to WIN initiated data communications.

In particular, in FIG. 9 a flow of firmware logic in a Gateway for WIN-initiated data communications is illustrated 900. At step 901 hardware and mesh network interfaces are initiated. Then the Gateway starts a countdown timer at step 902 and waits for the receipt of data or expiration of the timer at step 903. When the timer runs out at step 904 the Gateway returns to step 901 and reinitializes the hardware and network interfaces. If either data or a heartbeat is received then at step 907 the corresponding data is stored locally by the Gateway and the Gateway determines at step 906 if data should be send to the data center. At step 905 the Gateway sends data to the data center and in either case the Gateway returns to step 902 to start a count down timer for the receipt of data.

FIG. 10 shows a wireless interface node firmware flow chart relating to gateway initiated data communications.

In particular, in FIG. 10 a flow of firmware logic in a WIN for Gateway-initiated data communications is illustrated 1000. At step 1001 hardware and mesh network interfaces are initiated. Then the WIN waits for Gateway discovery on the mesh network at step 1002. After Gateway discovery, the WIN starts countdown timer T1 at step 1003 and then retrieves vending machine data at step 1004, compressing the retrieved data at step 1007 and starts another countdown timer (T2) for retrieving vending machine data at step 1006. The WIN then waits at step 1005 for a Gateway data request on the mesh network or a timeout of T2. If Gateway data is received at step 1009 the WIN sends compress data to the gateway at step 1010, resets countdown timer T1, and returns to step 1004 to retrieve vending machine data. If a time out of T2 occurs at step 1009 and a timeout of T1 occurs at step 1008 the WIN returns to step 1001 to reinitialize, otherwise the WIN returns to step 1004 to retrieve vending machine data.

FIG. 11 shows a gateway node firmware flow chart.

In FIG. 11 a flow of firmware logic in a Gateway for Gateway-initiated data communications is illustrated 1100. At step 1101 hardware and mesh network interfaces are initiated. Then the Gateway waits for discovery of all WINs on the mesh network at step 1102. At step 1103 the Gateway performs the following steps for each WIN discovered. A countdown timer is started at step 1107 and then at step 1106 the Gateway requests vending machine data from the WIN. The Gateway then waits for a response or the timer to timeout at step 1104. If the timer times out then at step 1110 the Gateway determines if all WINs have been processed and if not returns to step 1103 to continue WIN processing. If the Gateway received vending machine data from the WIN at step 1108, it locally stores the received data at step 1109 and goes to step 1110 to determine if more WINs need to be processed. If all WINs have been processed then at step 1112 the Gateway checks to see if it is time to send all stored data for WINs to the data center and if so, it sends all stored data to the data center at step 1111. If it is not time to send all stored WIN data to the data center then at step 1113 the Gateway waits a predetermined number of seconds before returning to step 1103 to again process all WINs.

In a preferred embodiment, a WIN 103 comprises an off-the-shelf wireless mesh networking hardware component, such as the EkaNet Node 200 from Eka Systems illustrated in FIG. 2 and further described in Appendix B, modified to include additional firmware specifically for the vending machine serial data interface 111 of the present invention, as illustrated in FIG. 3. All wireless mesh networking capability is contained in on-board firmware provided by the hardware vendor of the WIN 103. There are a number of manufacturers that produce wireless mesh networking hardware of this type.

FIG. 5 illustrates a preferred embodiment of a vending machine 102 employing a system with a gateway node with GSM cellular connectivity 500 and a wireless gateway node 105 comprising the same off-the-shelf hardware component as used in a WIN 103 (e.g., an EkaNet Node 200) that further comprises firmware specifically for a gateway interface 105. Additionally, in the gateway node 105, an off-the-shelf hardware component (not shown) is connected to the wireless gateway node hardware as needed to support the appropriate wide-area data communications 107. In a preferred embodiment, this additional hardware component is a cellular data modem, such as the Spider SA-GL from Enfora 114 illustrated in FIGS. 4 and 5 and described in Appendix C.

In alternative preferred embodiments of a vending machine 102 with a gateway node 105, other hardware components for wide-area connectivity can substitute for the GSM modem shown in FIG. 5. These alternative hardware components can include telephone modems 116 for a vending machine with a gateway node with telephone connectivity 600 (FIG. 6) and serial to Ethernet devices 119 for a vending machine with a gateway node with Internet connectivity 700 (FIG. 7).

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation, such as using different WIN devices and different WAN connectivity devices for the gateway node 105 and the teaching of the present invention can be adapted in ways that are equivalent without departing from its central scope. Further, the firmware flows illustrated in FIGS. 8-11, are for illustrative purposes only and the same functionality can be accomplished by equivalent logic. Therefore it is intended that the present invention not be limited to the particular embodiment disclosed as the best mode contemplated for carrying out the present invention, but that the present invention include all embodiments falling within the scope of the appended claims.

### APPENDIX A

### V-COMMERCE: Understanding Vending Machine Technology

by Michael L. Kasavana, Ph.D., CHTP

Sidebars: Vending Technology Terminology and Vending Technology Web Sites

The potential impact of automatic merchandising (i.e. vending) on the hospitality industry may be significant as innovative smart machines, seamlessly integrated with property management systems, possess the capability to enhance guest services while reducing labor cost and increasing profitability. As the labor market remains challenging, hospitality management may seek alternative product delivery methods to maintain guest services and profitability. Given the technological advancements in automatic merchandising and vending information systems (v-commerce), hospitality practitioners should consider using vending equipment in innovative ways to exceed guest expectations. V-commerce is capable of improving productivity, expanding guest services and presenting a platform for competitive advantage. It is time to consider unattended points of sale as a mainstream hospitality information system application, not as an auxiliary function for outsourcing.

During the past few years, the vending industry has been inundated with hardware devices designed to tightly control unattended transactions, software applications governing inventory replenishment and sales reconciliation, and netware for wide area connectivity (wired or wireless) for real-time data sharing. Historically considered a low-tech industry, the introduction of sophisticated automation has revolutionized the vend channel.

Vend Operators

Advances in equipment technology and computer software are giving vend operators more control of their business. These tools are providing benefits in many operational areas, including: route management, service scheduling, cash accountability and product selection. For most operators, accountability at the route and/or machine level is a top priority in choosing application software. The ability to choose a more profitable product mix is usually further down on the list of most operators' priorities. This is mainly because there is often a misconception between popularity and profitability. The long-term impact of promoting less profitable items, can be dysfunctional. While only a small percentage of vend operators have begun to utilize much of the newer technology, the trend is quickly shifting. Change is occurring in the form of V-commerce.

V-Commerce

V-commerce technology devices provide an increased number of unattended points of sales with online transaction processing capability. Such developments represent a significant cost containment strategy for the historically labor-intensive hospitality industry. V-commerce is the term used to describe the nearly unlimited range of advanced automatic merchandising technology application opportunities available to the vending industry. For decades vending equipment has been a hidden or auxiliary operation in the hospitality environment. Few operators have noticed vending machine reliability, efficiency or opportunity. As the labor market remains tight, replacement of staff with sophisticated unmanned distribution technology may begin to appear more attractive. Why shouldn't a guest be able to insert a room key into a vending machine so that transactions can be posted to a folio? What about delivery of upscale snacks or quality foodservice products via machine? Why not dispense towels and market health products poolside without requiring an attendant? How about breakfast delivery mechanisms for budget properties? As the potential for numerous applications become more apparent, v-commerce initiatives are expected to propel automatic merchandising into the mainstream of hospitality business applications. Decisions concerning machine content and fulfillment reside with development of a plan-o-gram.

Plan-o-Grams

Initially product manufacturers introduced sample plan-o-grams as a means of providing a simplistic way for sorting category databases into product selections. Software companies now offer plan-o-gram modules and sales analysis tools as an aid to better, more informed product selections. Despite the fact vend operators tend to recognize the conceptual benefits of plan-o-gram mappings, management has been resistant to widespread implementation. Since vend operators have historically empowered route drivers to select a majority of the products for their routes, there is hesitancy to change these practices and have the product manufacturer or distributor make product decisions. To fully implement plan-o-gram mapping, for example, a distributor may be required to adjust its warehouse organization to more closely parallel system requirements. Plan-o-grams are typically organized according to location type (office, schools, factories) and/or machine configuration (32-select or 45-select). The amount of support work required will depend on how frequently and to what degree the plan-o-gram changes (weekly, monthly, quarterly).

Most plan-o-gram maps are composed of two types of products: core products and cyclical products. Popular and profitable items are deemed “core” and simply are constant inclusions on successive plan-o-grams. Items that move on and off the plan are labeled “cyclical” and may or may not be included in the next plan-o-gram. To date, most plan-o-grams are calculated on a monthly to quarterly schedule basis and the ratio of core products to cyclical products can vary considerably. Full row and column tracking with historical sales data is used to determine core products and to predict future product movement. A plan-o-gram analysis basically enables projections based on item-level financial data to determine product rotation groupings. Plan-o-grams provide a tool to ensure better selling items are in all machines. When product accountability is added to a plan-o-gram the vend operator becomes capable of managing product categories, a macro-level practice known as category management.

Category Management

Like some restaurateurs, vend operators may choose products (menu items) based on sales, not profitability. In the mid-1990s, companies such as Nabisco Inc., Frito-Lay Inc., Hershey Foods and M&M/MARS began educating operators about category management, product selection processes, and product specific strategies. Category management (CM) is an approach by which manufacturers, distributors and/or suppliers manage groups of products efficiently with respect to pricing, merchandising, promotion and availability (product selection). The goal of CM is to increase sales and profitability through coordinated efficiency at both route and warehouse levels by assisting vend operators with space optimization (most dollars from fixed space), while satisfying consumer demand.

It is not commonly known that, for the most part, vending machine product offerings are selected by route drivers, based on their experience or gut feelings, rather than by using any systematic, fact-based information. Their attempts to fill the machines simply with as much product as possible, cause warehouses to saturate stock keeping units. In other words, their decision on product selection in limited vending machine space might not always meet consumer preferences. Consequently, consumers may walk away from the machines.

CM is an important concept because it provides a basis for improvement in overall contribution margin by focusing on consumer behavior, rather than solely on buyer-to-seller transactions. Understanding consumer behavior allows operators' to make decisions that include a sound product mix (e.g. candy, snacks, beverages, coffees, etc.) as well as a planned item rotation to enhance revenue opportunities. Category management is critical to vending since machines have limited space, compared to other retail channels.

Basically, category management provides vend operators with the ability to choose appropriate product categories, allocate slots/spirals/space effectively, develop a profitable product mix, while providing a blueprint for machine menu planning.

Automating Category Management

Category management is essentially a four-step process: 1) category identification, 2) space allocation to categories, 3) product selection and 4) menu cycle rotation. Category identification simply involves delineating available item categories (e.g. snacks, beverages, candy, etc.) across all possible choices. A determination is then made as to which product categories will be represented in a specific vending machine. Space is allocated accordingly. Product selection within categories is important to maximizing sales and profitability. By identifying types of products, such as core products and cyclical products, flexibility and variety can be achieved.

Vend operators are aware that not all items or categories are traffic generators or profit generators. Vendors often carry items that are low in margin, low in sales and low in demand and may not know it! Vend operators need to understand how each core product, primary product and rotational product contributes to the sales mix and profit portfolio.

Advanced Technologies

While some vending operators have migrated to a cabled, network-centric system, the advancement of wireless technology has emerged as an attractive alternative. Wireless applications possess tremendous potential for the vend industry, an industry that desires mobility, flexibility and reliability in enterprise-wide operations. Vending practitioners dissatisfied with the constraints and complexities of hard wiring are migrating to the convenience of design portability and user mobility that wireless technology solutions provide. Operators already have begun benefiting from the evolution of such devices as hand-held terminals, personal digital assistants, smart paging units, global positioning systems, telecommunication links (telemetrics), proximity transponders and related devices.

DEX Standards

DEX is an acronym for Data Exchange and is the abbreviation for DEX/UCS which stands for Data Exchange Uniform Code Standard. DEX is the key to technological advancements in the vending industry worldwide. Since DEX/UCS recently received international consensus support, industry experts believe this will further facilitate a movement toward consistent data formatting. In the past, machine manufacturers varied in how data exchange transmissions occurred. Now DEX designers and equipment engineers have agreed on a common linkage. While not all vend operators demand identical informational output, machines will possess similar data capabilities for delivering consistent reports. For example, common data set elements in the DEX standard are number of bills held in the bill stacker, quantity and denomination of coins stored in the coin box, machine inventory, and product sales tracking. Given recent DEX developments, coupled with the fact that vending machines have an average life of 10 years, it may take a generation of new machine installations to fully realize the DEX potential. Many industry practitioners claim DEX provides an indisputable, auditable accounting method for actual cash collections, units sold, and product price.

During the past decade, the National Automatic Merchandising Association (NAMA) established a communication protocol for the electronic retrievable of machine-level information via data polling. As a consequence, vending machines are now manufactured as DEX-enabled and are often labeled as DEX-compliant. Basic DEX extraction includes sales, cash collections, product movement (sales mix) and related information. DEX data retrieval can be accomplished via three distinct polling modes: 1) local polling, 2) dial-up polling or 3) wireless polling.

Local polling incorporates a hand-held device (or pocket probe) designed to plug connect to a machine-based DEX-port. Once the connection is established, the device is used to download transactional data. A typical DEX data download (machine to hand-held device) takes approximately five seconds. Field collected data is later transferred from the hand-held device to a central office computer for processing and analysis.

Dial-up polling (telephone line), and wireless polling enable remote access to DEX data without requiring a physical presence at the point of transaction. Once a valid connection is established, DEX data can be collected to evaluate and analyze. DEX-enabled handhelds plug into a vending machine port and automatically download stored data. While most information deals with sales, there are several important elements of auditing. For example, how much cash should be in a machine at the close of a sales period? A route driver, unable to view the DEX electronic record, will have cash collections compared against the machine-level electronic record.

A DEX-enabled machine relies upon a DEX add-on to enable a handheld device to be plugged into the back portion of a vending machine. The vending machine then communicates its unique identifying number and stored data is extracted. An important element of this data is the machine's service history, including the last date the machine was serviced. Once the route driver transfers DEX information to the handheld and in turn relays it back to headquarters, an audit can be performed. Since captured data is not accessible or editable by the route driver, cash accountability is assumed accurate and complete. Also, the ability to track product information at the machine level enhances productivity as a route time is improved and manual data entry is eliminated.

DEX specifies a data format to enable all different types of machines and machine models to communicate electronically in a similar manner. The DEX information available includes: sales, cash collections, product movement and other vending machine activities. Additionally, the DEX specification contains a standard for reporting error codes for payment validation, jams and other operational problems, all of which use ASCII text blocks for report generation.

The main benefit of line-item tracking is accountability and machine menu development. A DEXBuzzBox system operates through a wireless transmitter installed in a DEX-equipped vending machine that transmits machine-level data to a receiver (BuzzBox) in the route driver's truck. The BuzzBox may be equipped with a portable printer and a hand-held computer. The BuzzBox can be used to determine which machines at the location require service (which do not) and generates a detailed pick list for the driver to restock the machines prior to entering the facility. The driver's productivity is enhanced as there is only one trip into the building.

Cashless Vending

Consumers appreciate convenience, and cashless vending offers convenience. Cashless payment has proven to increase customer spending and attract new customers—without costly security overheads associated with cash. Cashless payment options include credit and debit cards, cellular handsets, RFID, payphone cards and electronic purse or smartcards. Cashless transactions require authorization that likely requires the use of telemetry. Telemetry is defined as the technology of automatic measurement and transmission of data by wire, radio or other means from a remote source. For vending, telemetry usually refers to the use of telecommunication equipment to complete a network topology. Cashless transactions may not be the most important advantage telemetry offers, but cashless systems do represent one of telemetry's most obvious benefits. In addition, once connectivity is achieved, vend operators will be able to transmit sales information, change selling prices, and monitor inventory and machine functions/malfunctions remotely. Telemetry offers improved product accountability, reduced cash liabilities and enables quicker transaction times. Convenience translates into higher sales, while improved efficiencies should result in more profitable operations. Some cashless vending machines are also equipped with an innovative feature called e-Port. E-Port is an interactive media screen that can project advertisements or online news content as an enticing draw for consumers. The e-Port package includes a card reader, an interactive media monitor and remote monitoring service.

According to manufacturers a machine can be equipped with a credit/debit card reader for several hundred dollars. With $10 to $15 per month needed for the telemetry, experts claim the full cost can be recovered within a year for many vending locations. Card system providers report field tests have shown these readers boost sales by 20 to 30 percent. Participating vendors agree. In addition, card purchases create an electronic trail of what was purchased, when and by whom. Also, cashless transactions are faster, avoid change deployment and simplify cash accountability. Cashless systems can also feature loyalty rewards and gift cards and purchase points.

Future Applications

Wearable computers, not just authorization chips, form the basis for an innovative set of communication and reporting applications some vending operators are contemplating. Body-worn technology suggests powerful applications capable of significantly impacting both on- and off-premise services including route management, data mining, product replenishment, menu engineering, and labor productivity. In addition, the recent proliferation of vending company web sites, supporting a variety of online opportunities, provides a solid base for expansion into sophisticated online purchasing, virtual private networks, training and other web-based applications, including cyber-wallets or e-wallets and information portals.

Summary

The hospitality industry faces a challenging labor market. A popular but seldom considered mainstream opportunity exists in the application of unattended points of sale, better known as automatic merchandising. Advanced electronic capabilities that enable remote machine monitoring, mobile phone activated purchases, and card-based transactions are being rapidly adopted. As telemetry applications and cashless transactions alter the vending landscape, hospitality management would be wise to investigate the potential benefits of vended operations.

Michael L. Kasavana, Ph.D., CHTP, is NAMA Professor in Hospitality Business School of Hospitality Business Michigan State University. Kasavana is also a member of the HFTP Communications Editorial Advisory Council.

[image]

[image]

[image]

We claim:

1. An apparatus for monitoring a vending machine, comprising:
a wireless interface node having a serial data interface for receipt of at least one vending machine status data, operatively coupled to a transceiver for sending and receiving said at least one vending machine status data over a mesh network; and
a vending machine controller for monitoring the status of the vending machine and operatively coupled by a first serial data link to said wireless interface node to output said monitored status as said at least one vending machine status data to said serial data interface thereof.

2. The apparatus of claim 1, wherein said at least one vending machine status data is formatted according to the DEX/UCS standard.

3. The apparatus of claim 1, wherein said wireless interface node is an EkaNet node and the serial data interface is an added firmware component.

4. The apparatus of claim 3, wherein said at least one vending machine status data is formatted according to the DEX/UCS standard.

5. The apparatus of claim 4, wherein said first serial data link is an RS-232 serial link.

6. The apparatus of claim 5, wherein said wireless interface node is further configured as a gateway node for receiving said at least one vending machine status data and sending said received at least one vending machine status data to a vending company data center over another network than the mesh network.

7. The apparatus of claim 6, wherein said gateway node further comprises a component selected from the group consisting of a GSM modem, a CDMA modem, a telephone modem, and a serial to Ethernet converter that is operatively coupled to said wireless interface node via a second serial data link to receive said at least one vending machine status data and said other network is respectively a GSM cellular data network, a public telephone system network, and the Internet.

8. The apparatus of claim 7, wherein said received at least one vending machine status data is compressed data formatted according to the DEX/UCS standard.

9. The apparatus of claim 8, wherein said second serial data link is an RS-232 data link.

10. The apparatus of claim 1, wherein said wireless interface node is further configured as a gateway node for receiving said at least one vending machine status data and sending said received at least one vending machine status data to a vending company data center over another network than the mesh network.

11. The apparatus of claim 10, wherein said gateway node further comprises a component selected from the group consisting of a GSM modem, a telephone modem, and a serial to Ethernet converter that is operatively coupled to said wireless interface node via a second serial data link to receive said at least one vending machine status data and said other network is respectively a GSM cellular data network, a public telephone system network, and the Internet.

12. The apparatus of claim 11, wherein said received at least one vending machine status data is compressed data formatted according to the DEX/UCS standard.

13. The apparatus of claim 12, wherein said second serial data link is an RS-232 data link.

14. The apparatus of claim 13, further configured to send and receive data over an alternative wireless data link.

15. A wireless network for monitoring the status of a plurality of vending machines, comprising:
at least one of said plurality comprising an apparatus according to claim 9;
at least one other of said plurality comprising an apparatus according to claim 5.

16. A system for monitoring the status of a plurality of vending machines comprising:
at least one wireless network according to claim 15; and
at least one computer system comprising a network interface to receive said at least one vending machine status data, a processor, an electronic database, and a vending machine monitoring software module to be executed by said processor to process the received at least one vending machine status data and store said received and processed at least one vending machine status data in said electronic database.

17. A method for monitoring a plurality of vending machines comprising the steps of:
modifying Wireless interface nodes (WINs) with firmware for a serial data interface;
equipping each vending machine of said plurality with a smart controller;
installing the modified Win in each vending machine of said plurality that is equipped with a “smart” controller;
each installed WIN periodically performing the steps of:
a. using a serial data link to retrieve a data set from the smart controller that is co-located in the same vending machine,
b. if any reportable change in the data set has occurred, transmitting the data set to a vending company data center via a gateway node reached by a data link selected from the set consisting of a wireless mesh network 109 and an alternate wireless data link, and
c. if no change in the data set is detected for a predefined continuous period of time, transmitting a “heartbeat” signal to indicate that it is still operating properly.

18. The method of claim 17, wherein the transmitting steps respectively further comprise the step of forwarding the data set and the step of forwarding the heartbeat signal to the vending company data center over a wide-area network communications link.

19. The method of claim 18, wherein the Wide-area communications link is selected from the group consisting of telephone modem, cellular data link, and Internet connection.

20. The method of claim 19, further comprising the step of when received in the vending company data center, storing the data set in a vending machine database for further processing.

21. The method of claim 20, wherein the data set comprises a DEX/UCS industry standard format.
